(19) United States
(12) Patent Application Publication
(10) Pub. No.: US 2025/0029046 A1
(43) Pub. Date: Jan. 23, 2025

(54) SYSTEM ADJUSTMENT BASED ON RISK

(71) Applicant: Egress Software Technologies IP Limited, London (GB)

(72) Inventors: Anthony Robert PEPPER, London (GB); Neil Tony LARKINS, London (GB); Jack Alexander CHAPMAN, London (GB); James Peter SHELDRAKE, London (GB); Thomas HAZELL, London (GB)

(21) Appl. No.: 18/774,060

(22) Filed: Jul. 16, 2024

Related U.S. Application Data
(60) Provisional application No. 63/514,023, filed on Jul. 17, 2023.

(51) Int. Cl. G06Q 10/0639; G06Q 10/0635

(52) U.S. Cl. CPC G06Q 10/06393; G06Q 10/0635

(57) ABSTRACT

A method and system for adjusting properties of another system based on a risk score associated with an entity, using a framework comprising a server having a risk determinator, an API, and storage for storing a risk profile associated with the entity and a risk property associated the risk profile. The method is performed by the server, and comprises obtaining, from the storage, the risk profile associated with the entity, where the risk profile is generated by a risk determinator, and based on at least one risk property. The risk determinator generates the risk score associated with the entity based on the risk profile, and the server determines an adjustment to the properties of the system based on at least the risk score. The adjustment is output, through the API to the other system.

### CROSS-REFERENCE TO RELATED APPLICATIONS

This application claims the benefit of U.S. Provisional Application No. 63/514,023, filed Jul. 17, 2023. The above-referenced patent application is incorporated by reference in its entirety.

### FIELD OF THE INVENTION

The present disclosure relates to a method, system, and computer-readable storage medium for adjusting the properties of a system based on a risk score. More particularly, the present disclosure relates to techniques for determining how to adjust the system based on a risk score associated with given entities.

### DESCRIPTION OF THE RELATED TECHNOLOGY

Communication systems have become an integral part of modern society, enabling the exchange of information, and facilitating various types of interactions. However, the increasing reliance on communication systems has also made them attractive targets for malicious activities, such as hacking, unauthorized access, data breaches, and other security threats. As a result, it is crucial to develop methods and systems to evaluate the security position of communication systems, identify potential vulnerabilities, and assess the associated risks.

Existing approaches to assessing security risks in communication systems often rely on manual evaluations or simplistic metrics, which may not accurately capture the complex interdependencies and evolving nature of modern communication systems. These approaches typically lack the ability to analyse multiple factors that contribute to the overall risk profile of a communication system, including network architecture, software vulnerabilities, user behaviour, system configurations, and external threats.

Moreover, these existing approaches often overlook the specific risks associated with individual users or groups of users within a communication system. User-related risks can significantly impact the overall security position of a system. However, conventional risk assessment methods fail to adequately address this aspect and provide a holistic view of the risks.

### SUMMARY

According to aspects of the present disclosure, there is provided a method as set out in the appended claims, a computer program product such as a non-transitory storage medium carrying instructions for carrying out the method, and a system comprising at least a server, and a storage system configured to perform the method.

The method comprises adjusting properties of at least one system based on a risk score associated with an entity, using a framework, the framework comprising a server comprising a risk determinator; at least one application programming interface, API facilitating communication between the server and the at least one other system; and storage for storing at least one risk profile associated with the entity and risk property scores associated with each of the at least one risk profile.

The method, performed by the server, includes obtaining, from the storage, the at least one risk profile associated with the entity, wherein each risk profile is generated by the risk determinator, and based on at least one risk property associated with the at least one risk profile; generating, by the risk determinator, the risk score associated with the entity based on the at least one risk profile; determining, by the server, at least one adjustment to the properties of the system based on at least the risk score; and outputting, through the API, the one or more adjustments to the at least one other system.

By determining adjustments to be made to a system based on risk scores associated with a particular entity, settings and/or properties of the system can be customized based on perceived, potential, and actual threats linked to the entity using the system. This enables risks to be mitigated in an efficient manner, such that the settings/properties of the system are set to a suitable level based on the entity's requirements. Furthermore, generating an overall risk score based on risk profiles (each of which is based on risk properties) advantageously means that e.g. one low-risk profile does not completely negate a high-risk profile. The determination of the risk profiles is based on risk properties and may be generated using the same/similar methodology, thereby enabling a hierarchy of scores to be determined to generate a more accurately overall risk score for the entity (or entities), in a more efficient manner.

The entity may be an individual user of the system, a group of associated users within an organization, or all user in an organization. This enables different levels of entity to be considered when determining risk scores. It enables an organization view, group view, or individual user view to be considered when determining the adjustments to the system, thereby enabling more tailored adjustments to be made in order to mitigate risk appropriately for the given entity.

Optionally, when the entity is all users associated with the organization, at least one of the risk profiles is the risk score generated by the risk determinator based on the group of users within the organisation, and/or one or more individual users. Alternatively, when the entity is the group of associated users within the organisation, at least one of the risk profiles is the risk score generated by the risk determinator based on one or more of the individual users in the group of associated users within the organization. This enables a hierarchy of risk scores to be determined at multiple levels in the organization in order to set risk mitigation appropriately for each entity.

The risk score may be generated using a weighted average algorithm. The weighted average algorithm may comprise calculating a mean for a plurality of risk profiles; for each risk profile, calculating a weight based on the distance from the mean; multiplying each of the plurality of risk profiles by the calculated weight to determine a plurality of weighted risk profiles; and calculating a mean of the plurality of weighted risk profiles. Using a weighted average algorithm enables accurate assessments of risk, since outlying results do not disproportionately affect the overall risk score. That is where an entity has both a high risk profile and a low risk profile these do not completely offset each other, and higher scores are weighted more disproportionally than lower scores to more accurately reflect the actual risk associated with entity.

The one or more adjustments to the at least one other system may comprise at least one of: lowering the risk score threshold required for a communication to be deemed suspicious or dangerous; automatically quarantining incoming messages for a period of time; requiring outgoing messages to be approved; reducing the rate at which an entity's trust level increases; increasing data analysis by machine learning models for a higher-risk entity; blocking an entity from interacting with content in; and amending an entity's training profile in a training system. Adjusting the system based on the risk score enables identified risks to be mitigated. The level of mitigation, and the adjustments undertaken may be based on the risk score, so the higher the risk the more adjustments are required, and/or the intensity of those adjustments is increased.

At least one of the risk profiles and the risk property may be based on an entity profile associated with the entity and obtained from at least one of: a third-party source; and data stored on the internet. The entity profile may be used to determine the level of risk and inform the risk properties used to determine the risk profiles. By analysing the entity profile, data such as the entity's communication history, training history, and current permissions/settings may be used to inform the likely risk level that the entity poses, thereby enabling more accurate risk scores (and therefore adjustments to the system(s)) to be determined.

The at least one risk profile may comprise at least one of: inbound communication data; outbound communication data; open-source intelligence, OSINT, data; data associated with the system; data associated with the entity; and the entity's training profile held by a third-party training organisation. By considering data from a number of sources, different risk profiles for each entity may be determined, and used when determining an overall risk score. This, therefore, enables subsequent adjustments to the system to be made. This provides a more accurate assessment of the actual risk of the entity and improves the risk mitigation required by the system.

Optionally, the at least one risk property may be based on an analysis of one or more properties associated with the at least one risk profile at a given point in time or based on a predetermined decay variable. By using risk properties which are both fixed at a given point in time, and which decay at a given rate, different types of risk property can be considered in different ways. In this way, older risk property data may have less of an impact on the risk score than newer risk property data, and may result in a more accurate risk score being generated.

Further features and advantages of the disclosure will become apparent from the following description of preferred embodiments of the disclosure, given by way of example only, which is made with reference to the accompanying drawings.

### BRIEF DESCRIPTION OF THE DRAWINGS

FIG. 1 shows schematically a framework, according to an example;

FIG. 2 is a flowchart showing a method for determining adjustments to a system based on a risk score associated with an entity, according to an example;

FIG. 3 is a schematic representation of an organization, according to an example;

FIG. 4 is a representation of the generation of a risk score according to a first example;

FIG. 5 is a representation of the generation of a risk score according to a second example; and

FIG. 6 is a schematic representation of a system used for determining adjustments to another system based on a risk score associated with an entity, according to an example.

### DETAILED DESCRIPTION OF CERTAIN INVENTIVE EMBODIMENTS

Existing approaches to assessing risks in communication systems often overlook the potential impact of adjusting system properties for specific entities that use the system. System properties, including configuration settings, network architecture, and security controls, play a crucial role in mitigating security vulnerabilities and reducing the risk of unauthorized access or data breaches.

However, conventional risk assessment methods typically do not consider the dynamic nature of entities and their influence on the overall security risk for a system. Each entity, such as a user or a group of users, may have unique requirements, privileges, and potential vulnerabilities that should be considered when evaluating the security risks, they pose.

The ability to adjust system properties based on an entity-specific risk assessment is essential for tailored risk management. By identifying weaknesses or vulnerabilities specific to an entity and making appropriate adjustments, security administrators can effectively reduce the risk associated with that entity.

Embodiments of the present disclosure will now be described with reference to:
1. A framework for adjusting a system based on a risk score associated with an entity;
2. Determining adjustments to be made to a system; and
3. A system for generating a risk score and determining adjustments.

### 1. THE FRAMEWORK

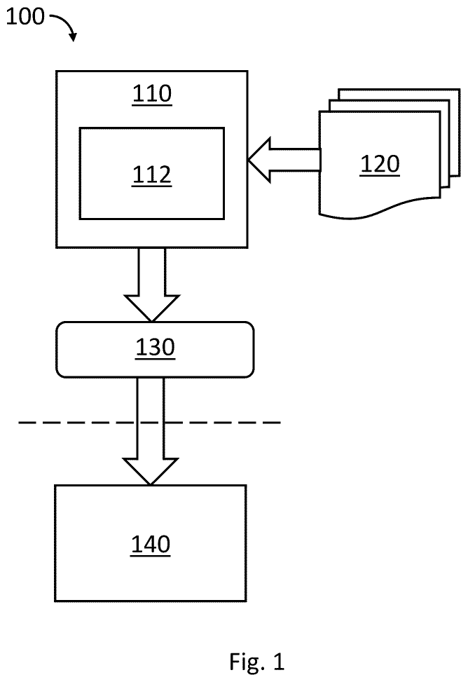

FIG. 1 shows schematically a framework 100 for adjusting a system based on a risk score associated with an entity. The framework 100 comprises at least a server 110 having a risk determinator component 112, storage system 120, and an application programming interface (‘API’) 130.

The framework 100 is arranged to determine one or more risk scores associated with an entity, and based on that risk score, determine one or more adjustments to make to a system 140. The system 140 may be associated with the framework 100, such as a system operated by the same provider, or in some examples the system 140 may be a third-party system provided by an external provider. The system 140 may be accessible via the Internet, and the framework may interface with the system 140 over a network, and through the API 130, to provide the adjustments required. A user, such as a system manager and/or administrator may access the resources associated with the framework 100, such as the server 110 and the storage system 120, via a user device configured to operate a software program such as a web browser or other application installed on the user device. Access to the framework 100 via such a device may be via the API 130, or another API (not shown) specifically used for management/administration purposes.

The user may interact with the framework 100 to adjust one or more properties. For example, interaction with the framework 100 may comprise modifying the level and types of adjustment to be made to the system 140, setting certain risk thresholds, and adding or modifying existing, risk profiles, risk properties, and a weighting algorithm (described below). Access to the framework 100 by the user may also enable them to enable/disable certain features of the framework 100, such as operating in a sandbox/experimental mode. This allows the changes made to the framework 100, and in particular the determination of risk and adjustments to be made, to be analysed, tested, and validated prior to release. It also enables comparisons to be made between the modified components and the existing, live, components to determine their overall effect on the system 140.

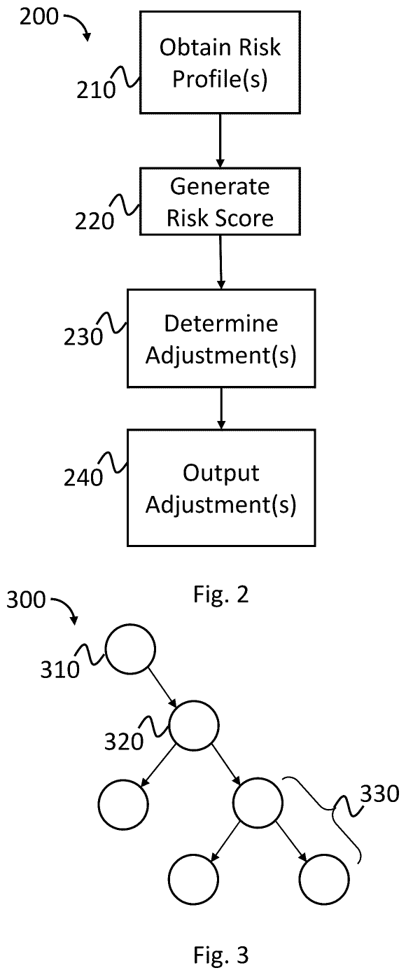

The framework 100 comprises a server 110 configured to perform at least one of the actions described below in relation to FIGS. 2-5. The server 110 may be hardware-implemented or software-implemented (e.g., a virtual machine) and configured to receive data from the storage system 120. The storage system 120 is configured to store risk profiles and associated risk properties which are used by the server 110 to generate a risk score. The risk score is used to determine one or more adjustments to the properties of the system 140. The storage system 120 may also be arranged to store other data for use by the server 110 and/or risk determinator 112 in generating risk scores and determining adjustments to be made to the system 140.

In some examples, the framework 100 may be separate from the system 140, and any other devices on a network. The storage system 120 may form part of the same server 110 or may form part of another device such as remote storage in another server on the network.

In other examples, the framework may be implemented using cloud computing. Cloud computing is a model for service delivery enabling on-demand network access to shared resources including processing power, memory, storage, applications, virtual machines, and services, that can be instantiated and released with minimal effort and/or interaction with the provider of the service. Cloud computing environments enable quick and cost-effective expansion and contraction of such resources by enabling the provisioning of computing capabilities, such as server time and network storage as needed. Cloud computing enables the service provider's resources to be pooled and to serve multiple consumers by dynamically assigning and reassigning physical and virtual resources on demand. Examples of such services include Amazon Web Services™ (AWS), Microsoft Azure, and Google Cloud Platform.

Services delivered using a cloud computing environment are often referred to as a Software as a Service (SaaS). The applications are accessed from various client devices through a basic interface, such as a web browser. A user of the application generally has no control or knowledge over where the provided resources are located or in some examples where multiple service providers are used, which service provider is providing the resources; access to the resources of the cloud computing environments is provided via a user account object which facilitates the user's interaction with the resources allocated to a given task within the cloud computing environment. Whilst a cloud computing environment is one of the configurations capable of implementing the framework 100, it will be appreciated that other environments may be used, such as a collection of servers within a local area network (LAN).

In the examples described below, the framework 100 may be provided as a service to one or more devices configured to implement the risk score and adjustment determination schemes.

### 2. ADJUSTMENT DETERMINATION

FIG. 2 is a flowchart showing a method 200 for determining adjustments to be made to a system, such as system 140 described above, based on a risk score associated with an entity. The method has two distinct parts which will be described in further detail below:
i. The generation of a risk score for a particular entity, which will be described with reference to:
   a. Risk Profiles and Risk Properties;
   b. Determining Risk Scores; and
   c. Worked Examples; and
ii. The determination of adjustment(s) based on the risk score.

When determining the adjustments to be made, consideration is given to the type of entity the risk score is associated with. The system 140 may be a communication system which employs a number of methods for analysing communications and determining whether they are likely to be a threat (e.g., a phishing communication, or the wrong recipient being listed in an outgoing communication). The adjustments output by the method may be used to adjust properties of the system such that the system 140 more accurately handles the risk associated with the particular entity. For example, the entity may be an individual user using the communication system, a group of users within an organization, or all users within the organization. Adjustments made to an organization-level system are likely to be different to adjustments made to individual users of the system. This provides a more tailored and holistic method of handling the associated risk, and the adjustments required to achieve the desired level of security.

i. Generation of Risk Scores

Referring to method 200 of FIG. 2, at step 210 one or more risk profiles are obtained from storage, such as storage system 120 described above in relation to framework 100. The risk profiles, as will be described in further detail below, represent the impact a particular characteristic may have. Examples of characteristics include the entity's risk to incoming communications, the entity's risk to outgoing communications, properties of the system associated with the entity, and the impact of third-party data on the entity's interaction with the system. It will be appreciated that other characteristics may be represented by the risk profiles. In some examples, the risk profiles may be based on risk scores generated for subsets of users.

The one or more risk profiles are generated by the risk determinator 112 before being stored in the storage system 120 for future use. The risk profiles are generated based on one or more risk properties associated with the risk profile.

Both the risk profiles and risk properties may be represented as a numerical value in a given range, e.g., between 1 and 10, where 1 represents low/absence of risk and 10 represents high risk. Examples of the risk profiles and risk properties will be described in further detail below, along with worked examples of their use in generating a risk score.

Once the risk profiles have been obtained from the storage system 120, at step 220 the risk score is generated. One such method of generating a risk score is to use a weighted average algorithm, an example of which is described in further detail below. It will be appreciated that other methods of combining the different risk profiles (and risk properties) may be used to generate the risk score for a particular entity.

### A. RISK PROFILES AND RISK PROPERTIES

Risk profiles are based on a number of characteristics associated with the particular entity's interaction with a system, such as a communication system. For example, where the communication system is an email system, then risk profiles may be based on a per-user (e.g., by email) basis in accordance with incoming and outgoing email messages. Other information may also form the basis of one or more of the risk profiles. This other information may relate to different types of system, other than communication systems, as will be appreciated by the skilled person.

Examples of risk profiles include:
Inbound Risk relating to data about incoming communications;
Outbound Risk—relating to data about outgoing communications;
Open-Source Intelligence (‘OSINT’) Risk—relating to information obtained from OSINT sources;
Intrinsic Risks—relating to data associated with the given entity and/or system itself; and
Third Party Risk Analysis—relating to data held by third-party services, such as a training provider (e.g., an entity's training profile).

Each of these risk profiles may be represented as a score between 1 and 10 (as will be described in further detail below) and may each be based on one or more risk properties. It will be appreciated that other risk profiles may be used, and that the list of risk profiles above is not limiting. It will also be appreciated that the risk profiles may be represented in any number of other ways, not just as a score between 1 and 10.

As mentioned above, the entity may be any of an individual user, a team of users, or all users in an organization. Where the entity is an individual user, the individual user risk score may be based on any combination of the risk profiles set out above (or others when relevant). In other examples, the entity may be a team of users in an organization. In this case, the team of users' risk score may be based on the risk profiles of the team (e.g., team Inbound, team Outbound, etc.) along with a further risk profile based on the individual user risk scores of the users that make up the team. Similarly, where the entity is all users within an organization, the risk score for the organization may be based on risk profiles of the organization (e.g., organization Inbound, organization Outbound, etc.) along with a risk profile based on the individual user risk score of users within the organization and/or risk profile based on the team risk scores of the teams within the organization. This may result in a more accurate representation of the risk.

Each risk profile may be generated by the risk determinator 112 in a similar manner to the overall risk score generated by the method 200 of FIG. 2. Each risk profile may be based on risk properties associated with the risks. Examples of risk properties include but are not limited to:
Risk Profile Inbound Risk—Risk Property: how many phishing messages an entity receives, whether there is an ongoing persistent threat;
Risk Profile Outbound Risk—Risk Property: how many times a ‘wrong recipient’ message is shown to a given entity;
Risk Profile OSINT Risk—Risk Properties: how many breachers an entity has been in; the number of unique compromised details in each breach;
Risk Profile Intrinsic Risk—Risk Properties: how far from the CEO is an entity; how long has the entity been part of the organization; and
Risk Profile Third Party Risk—Risk Property: does the training data obtained from a third-party training provider indicate a particular area/risk the entity is struggling with (e.g., detecting phishing details).

It will be appreciated that other risk profiles and risk properties may be used, such as the behaviour of an entity, along with other third-party data such as data obtained from device managers, and other third-party companies and databases. In some examples, files and/or data (e.g., associated with a communication) may be analysed and used to generate a risk profile.

As with risk profiles and the overall risk score, risk properties may be represented as a score between 1 and 10, and in some examples may either be static representing the score at a given point-in-time, or generational, representing a score which decays based on the time since certain events have occurred.

Where a risk property is static, the characteristic of the system may be evaluated at a given time, and a score output. For example, where Third Party Risk is representative of training data, the score obtained from the third-party training provider may be evaluated at the point in time that it is requested. That is if an entity's training score is 76, the risk property may be based on the score generated at the time of calculation. Conversely, where the risk property is generational, weights may be used such that older data has less of an impact on the overall risk score. This may be achieved using Equation 1 (below), which takes each score and multiplies it by a given weight before determining an average:

$$Generational Risk Property = ( \frac{( {G}_{0} \times {W}_{0} ) + ( {G}_{1} \times {W}_{1} ) + … + ( {G}_{n} \times {W}_{n} )}{( {W}_{0} + {W}_{1} + … + {W}_{n} )} ) \qquad ( Equation l )$$

Where G_{0 . . . n} represent the instances in a given period and W_{0 . . . n} represent the weights associated with each of the given periods. Examples of such generational properties, include data relating to how many phishing messages an entity has received (Inbound Risk), and how many time a ‘wrong recipient’ message has been shown to a given entity (Outbound Risk).

Each of the risk properties may provide their score (between 1 and 10) to be used in the generation of the risk profile based on other calculations. Examples of different calculations will now be described in further detail, although it will be appreciated that other methods of calculating each of the risk properties described below may be used. The skilled person will also appreciate that with other risk properties which have not be described may be used in the generation of the risk profiles.

### Inbound Risk—Number of Phishing Messages an Entity has Received.

The number of phishing messages received by an entity is an example of a generation risk property as older data is less relevant to the present risk for the entity. The generation of the risk property as a score may be based on the total number of phishing messages received in a given period such as within the last 90 days. In one such example, the given period may be split into a number of sub-periods such as 0-30 days, 31-60 days, and 61-90 days. It will be appreciated that the given period may be of different length and be subdivided into more or fewer sub-periods each having the same or differing lengths.

The score for each sub-period may then be determined based on the number of phishing messages received in that period. This may be based on data received from an external source, such as Egress Defend®, and consider the number of messages classified as dangerous (‘D’) or suspicious (‘S’) within each sub period. This may be combined in such a way as to provide a score for that sub-period by:

$$Score = Offset + {( 2 \times ( 4 \times D ) + S )}^{EXP} + ( 2.2 \times ( \frac{1}{1 + {e}^{( 0.8 - ( \frac{( ( 2 \times ( 4 \times D ) + S ) - 30 )}{60} ) )}} ) ) \qquad ( Equation 2 )$$

Where the Offset ensures any entity for which no data is available returns a low score (e.g., 1), and where EXP ensures that most users are given a baseline score. There is also a stretched sigmoid component which creates and appropriate tail between medium and high risk scores output by Equation 2.

In one example, the Offset maybe 0.4, and the EXP may be 0.25, however it will be appreciated that other values of Offset and EXP may be used.

As mentioned above, each sub-period may have a score generated by Equation 2 and may be weighted in such a way that the score from the most recent sub-period has a larger impact on the overall risk property Score than the score from later sub-periods. In one example, the weights may be:

$$Sub - period 1 ( 0 - 30 days ) = 10 \\ Sub - period 2 ( 31 - 60 days ) = 3.75 \\ Sub - period 3 ( 61 - 90 days ) = 1.5$$

It will be appreciated that other weightings may be used.

The scores and the weightings may then be input into Equation 1 (above) to determine an overall score for this risk property, as is show in Example 1 below.

### Outbound Risk—‘Wrong Recipient’ Advice Given.

As with the number of phishing messages received risk property described above, the ‘wrong recipient’ advice given risk property is also a generational risk property, as the entity's most recent behaviour is more relevant than historical data. The generation of the risk property, as a score, may be based on the total number of wrong recipient advice instances given in a given period such as within the last 270 days. In one such example, the given period may be split into a number of sub-periods such as 0-90 days, 91-180 days, and 181-270 days. It will be appreciated that the given period may be of different length and be subdivided into more or fewer sub-periods each having the same or differing lengths.

The score for each sub-period may then be determined based on the number of ‘wrong recipient’ advice instances in that period. This may be based on data received from an external source, such as Egress Protect®, and used in such a way as to provide a score for that sub-period by:

$$Score = 2 \times Advice {Instances}^{EXP} + 1 \qquad ( Equation 3 )$$

Where EXP represents the rate at which advice instances contribute to the score (i.e., the more instances the higher the score). In one example EXP may be 0.35, although it will be appreciated other values may also be used.

Each sub-period may have a score generated by Equation 3 and may be weighted in such a way that the score from the most recent sub-period has a larger impact on the overall risk property Score than the score from later sub-periods. In one example, the weights may be:

$$Sub - period 1 ( 0 - 90 days ) = 10 \\ Sub - period 2 ( 91 - 180 days ) = 6 \\ Sub - period 3 ( 181 - 270 days ) = 3$$

It will be appreciated that other weightings may be used.

The scores and the weightings may then be input into Equation 1 (above) to determine an overall score for this risk property, as is show in Example 2 below.

Intrinsic Risk—Distance from the CEO

FIG. 3 shows an exemplary organization structure 300 comprising a number of individual users including the CEO 310, and the target user 320 for which a risk score is being calculated. In this instance, the CEO 310 is one step above the target user 320, and the target user has two levels 330 within the organization below them.

The distance from the CEO is an example of a static risk property since it is evaluated based on the organization structure at the time of the risk property generation. In some examples, the closer the target user 320 is to the CEO 210 the higher the risk property as they are likely to have access to more sensitive information. Similarly, the number of levels 330 below the target user 320 may also be considered since the larger the number of levels the higher the higher the likelihood of the target user 320 having access to sensitive information about other users within the organization.

Intrinsic Risk—how Long has the User been with the Organization.

This risk property is a static calculation depending on the duration of service for a given entity at the organization. It will be appreciated that this may be calculated in a number of different ways. In one example, the risk property, y, associated with a given entity may be calculated based on:

$$For 0 - 16 months : y = ( \frac{1}{54} {( X - 16 )}^{2} ) + 3 For 16 - 36 months : y = 3 \qquad ( Equation 4 )$$

$$For 36 - 60 months : y = ( \frac{1}{193} {( X - 36 )}^{2} ) + 3 For over 60 months : y = 6 \qquad ( Equation 5 )$$

where X is the number of months the entity has been with the organization.

### Third Party Data Risk—Training Profile Score

A training profile score may be obtained from a third-party based on the entity's interaction with their system. This score may be provided in a number of formats. For example, from KnowBe4®, the score is in the range of 0-100. In such an example, the score received from the third party may be scaled to match the range of the risk property (e.g., 1-10).

### OSINT Risk—Number of Breaches

Data obtained from an OSINT source may be used to determine a risk property based on the number of breaches the entity's data is present in. The data may be obtained based on an entity profile associated with the entity stored in a database of the OSINT source. The entity profile may comprise data such as the entity's communication history, training history, and current permissions/settings may be used to search the OSINT source.

This is a static risk, which is calculated based on the available data at the time. For example, based on a large amount of data representing previous data breaches a risk property may be determined based on the number of breaches the entity's data is present in. This may be stored in storage, such as storage system 120, as a look-up table, such as:

TABLE 1

| Number of Breaches | Risk Property |
|---|---|
| 1 | 3.9 |
| 2 | 4.8 |
| 3 | 5.5 |
| 5 | 6.2 |
| 6 | 6.5 |
| 8 | 6.8 |
| 10 | 8.0 |
| 12 | 8.5 |

The risk properties in Table 1 may be calculated at regular intervals and updated based on any newly detected data breaches. It will be appreciated that the values listed in the risk property column of Table 1 may be different depending on the analysis of the data obtained from the OSINT source.

### OSINT Risk—Number of Compromised Details

Similar to the number of breaches property above, data obtained from OSINT may be used to determine a risk property score based on the number of unique compromised details in any detected breaches.

This is a static risk, which is calculated based on the available data at the time. For example, based on a large amount of data representing previous data breaches a risk property may be determined based on the number of unique compromised details associated with the entity (e.g., if ‘income level’ is in 4 of the 7 breaches, it would still only count as 1 unique instance). This may be stored in storage, such as storage system 120, as a look-up table, such as:

TABLE 2

| Number of Compromised Details | Risk Property |
|---|---|
| 1 | 3.0 |
| 2 | 3.4 |
| 3 | 3.8 |
| 4 | 4.0 |
| 6 | 4.5 |
| 8 | 5.0 |
| 10 | 5.75 |
| 12 | 6.0 |
| 14 | 6.2 |
| 16 | 6.4 |
| 18 | 6.8 |

The risk properties in Table 2 may be calculated at regular intervals and updated based on any newly detected data breaches. It will be appreciated that the values listed in the risk property column of Table 2 may be different depending on the analysis of the data obtained from the OSINT source.

### Other Entity Risks—Individual User Risk Scores

The risk scores generated for each individual user may be generated using the method 200 of FIG. 2, considering all the relevant risk profiles and risk properties associated with that user.

### Generating the Risk Profile Based on the Risk Properties

Each risk profile, such as Inbound Risk and Outbound Risk, is based on one or more risk properties. Whilst examples of the risk properties are described above, it will be appreciated that a number of other risk properties may be used to generate the risk profiles.

Each risk profile may be based on one or more risk properties. Where only a single risk property is to be used when generating the risk profile (e.g., the Inbound Risk being based on only the number of phishing messages received), then the risk profile has a score which is equal to that of the risk property (see Example 1, below). In other examples, where the risk profile is to be based on a plurality of risk properties, the individual risk property scores may be combined in any suitable manner (see Example 2, below). One such way of combining the individual risk property scores is to use a weighted average algorithm, such as the weighted average algorithm described below. The weighted average algorithm may be the same weighted average algorithm used to generate the overall risk score. In such examples, this enables hardware accelerated methods to be used efficiently since the same hardware components may be used to generate the risk properties as is used to generate the overall risk score for a particular entity. For example, the risk profile and associated risk properties may be managed and generated by the same risk determinator 112 used for the generation of the risk score.

Once the risk profile has been generated for a given characteristic associated with an entity, they may be stored in storage, such as storage system 120. Similarly, the individual risk properties may also be stored in the storage system 120. The storage system 120 may be associated with one or more systems used for determining the risk properties based on the entity's actions, such as storage associated with Egress Defend®, Egress Protect®, or Egress Prevent® for example.

### B. GENERATING RISK SCORES

Risk scores are based on at least one risk profile, and in some examples multiple risk profiles. The risk score reflects the level of risk each entity has; averaging the risk profiles to generate a risk score may result in an incorrect representation of the entity's overall risk. For example, having a low risk profile, does not completely offset a high risk profile. Therefore, risk profiles with a higher score may have a greater impact on the overall risk score than risk profiles with a lower score.

It will be appreciated that there are a number of methods for generating risk scores, and one example of such method is to use a weighted average algorithm to combine risk profiles so that risk profiles with high scores have a greater overall effect on the risk score than risk profiles with lower scores.

As mentioned above, the method used for generating the overall risk score may also be used to generate risk profiles when they are to include multiple risk properties. This results in the risk profile providing a more accurate representation of the risk in relation to that particular characteristic. That is risk properties with high scores will have a greater overall effect on the risk profile than risk properties with lower scores.

Furthermore, in some examples, risk profiles, risk properties, and overall risk scores may be capped to a given range. For example, where a range of 1-10 is required, any score which exceeds 10 may be capped at 10, and any score of less than 1 is capped at 1.

### Weighted Average Algorithm

As mentioned above, one method of efficiently generating an accurate risk score (or risk profile) is to use a weighted average algorithm. This weights each risk profile according to the mean of the risk profiles being considered when generating the risk score.

The first step is to calculate a mean for all risk profiles being considered as part of the risk score. Following the calculation of the mean a weight is calculated for each risk profile. Whilst there are many methods for calculating a weight, one such method is:

$$weight = ( ( \frac{( Risk Profile - Mean )}{Rang e} ) \times M ) + 1 \qquad ( Equation 6 )$$

where M is dynamically adjustable based on the number of risk profiles considered (e.g., where there are two risk profiles, M may equal 1.5, but where there are five risk profiles considered, M may equal 3). This enables the effect of the weighting to be accelerated or decelerated, and means that lower confidence data (i.e., data based on fewer risk profiles) has a smaller spread than higher confidence data, further improving the accuracy of the overall risk score. The Range is based on the range desired to be represented by the risk score (e.g., for a range 1-10, Range would equal 9).

Once the weight has been calculated for each risk profile using Equation 6, a weighted average score may be calculated using:

$$Weighted Average Score = ( \frac{( {S}_{1} \times {W}_{1} ) + ( {S}_{2} \times {W}_{2} ) + … + ( {S}_{N} \times {W}_{N} )}{N} ) \qquad ( Equation 7 )$$

where S_{1 . . . N} are the risk profile scores and W_{1 . . . N} represent the weights calculated using Equation 6. N is the total number of risk profiles used in the calculation.

### C. WORKED EXAMPLES

Worked examples of the above method of generating a risk score, as undertaken at step 220 of the method 200 of FIG. 2, will now be described. Two examples will be enumerated, however it will be appreciated by the skilled person that these examples are not limiting, and in other embodiments other risk profiles/risk properties may be used, as well as other methods of generating the risk score.

### Worked Example 1—Individual User Entity

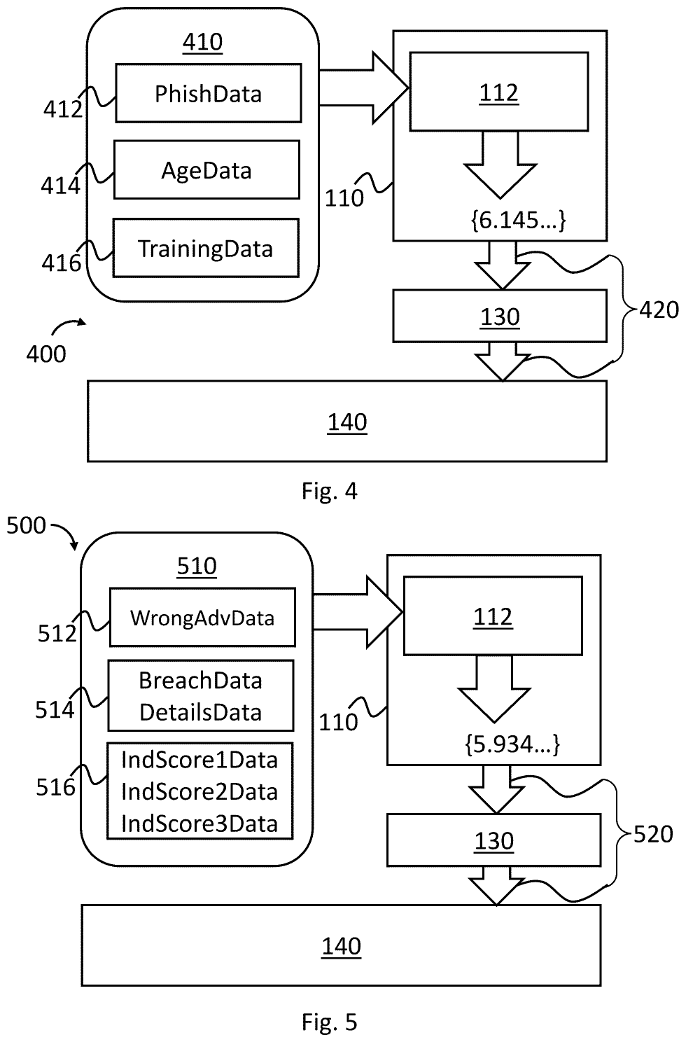

FIG. 4 shows an example 400 of the calculation of the risk score where the entity is an individual user 410 within an organization. This individual user 410 has a number of associated risk profiles-Inbound Risk 412; Intrinsic Risk 414; Third Party Data Risk 416. The risk profiles may be obtained from storage, such as storage system 120 described above in relation Framework 100. Each risk profile 412,414,416 may have one or more risk properties.

In this example, the Inbound risk profile 412 has a risk property representative of the number of phishing messages received. As described above, this risk property may be a generational risk property so that the more recent the data, the higher the impact on the risk profile. Data obtained from a service, such as Egress Defend® may indicate the number of phishing messages received over time, where each message is categorized as dangerous (‘D’) or suspicious (‘S). In this example, the following data is used:

$${G}_{0} ( 0 - 30 days ) = S : 4 // D : 1 \\ {G}_{1} ( 31 - 60 days ) = S : 10 // D : 5 \\ {G}_{2} ( 61 - 90 days ) = S : 2 // D : 0$$

Equation 2 (above) may be used to generate a score for each period. In this example, Offset is 0.4 and EXP is 0.25. This results in scores of:
G₀: Score=4.340 . . .
G₁: Score=6.016 . . .
G₂: Score=3.274 . . .

For each period G₀-G₂ a respective weighting may be applied such that more recent data has a greater impact on the output score. In this example, W₀ (0-30 days)=10; W₁ (31-60 days)=3.75; W₂ (61-90 days)=1.5. The weights for each period, along with each period's score may be input into Equation 1 (above) to generate the risk property Score:

$$( \frac{( 4.3 \; 40 … \times 10 ) + ( 6.016 ... \times 3.75 ) + ( 3.274 … \times 1.5 )}{( 10 + 3.75 + 1.5 )} ) = 4.648 … .$$

Turning to the Intrinsic risk profile 414, in this example, the risk property considered is length of service of the individual user 410 at the organization. For this worked example, the individual user has been with the organization for 45 months. Therefore, the risk property would be calculated using

$$( \frac{1}{193} {( 45 - 36 )}^{2} ) + 3 = 3.419 … . \qquad Equation 5$$

Similarly, for the Third Party Data risk profile 416, the risk property considered is a training profile score received from a third party training organization. In this example, a training profile score of 76 is received. This may be adjusted such that it represents a desired range. In this worked example, a range of 1-10 is required, therefore the training profile score is divided by 10 resulting in a Third Party Data risk profile of 7.6.

Each of the above risk properties may be generated by the risk determinator 112 of the server 110 described above in relation to FIG. 1 and stored in the storage system 120 for later use in the generation of risk scores. In this example, since each risk profile 412, 414, 416 are only made up of a single risk property the risk profiles 412,414,416 are equal to the calculated risk properties, that is:
Inbound risk profile 412=4.648 . . .
Intrinsic risk profile 414=3.419 . . .
Third Party Data risk profile 416=7.600

These risk profiles are obtained from the storage system 120 and used by the risk determinator 112 to generate a risk score. This risk score, as described above may be generated using a weighted average algorithm. The mean of the three risk profiles is obtained and equals 5.2223 . . . . This mean is then used as an input into Equation 6 to determine the weights associated with each risk profile. In this example, where M is 3, the weights are:
Inbound risk profile 412 weight=0.827 . . .
Intrinsic risk profile 414 weight=0.459 . . .
Third Party Data risk profile 416 weight=1.713 . . .

These weights, along with the risk profiles can be input into the weighted average algorithm (Equation 7) to generate an overall risk score:

$$( \frac{\begin{matrix}( 4.6 48 … \times 0.827 … ) + \\ ( 3.419 … \times 0.459 … ) + ( 7.6 \times 1.7 \; 13 … )\end{matrix}}{3} ) = 6.145 …$$

The risk score, as will be described below in relation to steps 230 and 240 of method 200 of FIG. 2, is then used by the server 110 to determine one or more adjustments 420 to make to the system 140. These adjustments 420 are determined with the aim of improving the risk mitigation/management and are then output to the system 140 via an API 130.

### Worked Example 2—Team of Users Entity

FIG. 5 shows an example 500 of the calculation of the risk score where the entity is a team of users 510 within an organization. This team of users 510 has a number of associated risk profiles-Outbound Risk 512; OSINT Risk 514; Individual User Risk 516. The risk profiles 512, 514, 516 may be obtained from storage, such as storage system 120 described above in relation Framework 100. The risk profiles 512,514,516 each have one or more risk properties. In this example, and as will be described below, the Individual User Risk 516 Profile may be based on risk scores calculated for one or more individual users (such as the Individual User in Example 1 above) using the same or a similar method.

In this example, the Outbound risk profile 512 may have a single risk property representative of the number of times wrong recipient advice has been given (i.e., ‘Did you mean X@Y.com instead of A@B.com’). As described above, this may be a generational risk property so that the more recent the data, the higher the impact on the risk profile. For example, data obtained from a service such as Egress Prevent® may indicate the number of times an individual user, or in this case the number of times members of the team, have been presented with a notification that the wrong recipient may have been entered (‘G’) for a communication. In this example, the following data is used:

$${S}_{0} ( 0 - 90 days ) = G : 20 \\ {S}_{1} ( 91 - 180 days ) = G : 4 \\ {S}_{2} ( 181 - 270 days ) = G 16$$

Equation 3 (above) may be used to generate a score for each period. In this example, EXP is 0.35, and results in scores of:
S₀: Score=6.706 . . .
S₁: Score=4.249 . . .
S₂: Score=6.278 . . .

For each period G₀-G₂ a respective weighting may be applied such that more recent data has a greater impact on the output score. In this example, W₀ (0-90 days)=10; W₁ (91-180 days)=6; W₂ (181-270 days)=3. The weights for each period, along with each period's score may be input into Equation 1 (above) to generate the risk property Score:

$$( \frac{( 6.7 \; 06 … \times 10 ) + ( 4.2 \; 49 … \times 6 ) + ( 6.278 … \times 3 )}{( 10 + 6 + 3 )} ) = 5.862 … .$$

Turning to the OSINT risk profile 514, this is made up of two risk properties, the number of data breaches users within the team have been part of, and the number of unique compromised details associated with those users. These are both static risk properties and may be determined based on an analysis of a large amount of data representing previous data breaches to determine the output. The number of breaches and compromised details may correlate with a given output based on this analysis, such as set out above in Table 1 and Table 2. In this example, the number of breaches the individual users within the team have been part of is 7, and therefore the score, based on Table 1, for this risk property will be 6.65 in this example.

In this example, within those 7 data breaches, 10 unique compromised details were obtained. As such, the score, based on Table 2, for this risk property will be 5.75.

As there are two risk properties making up this risk profile, a score based on these may be calculated. As set out above, this may use the same method as for generating the overall risk score. A mean score is generated, and then used to determine weights for each risk property, the risk properties and weights are then used in the weighted average algorithm to produce a score for the OSINT risk profile 514. In this example, the OSINT risk profile 514 would be:

$$( \frac{( 6.65 \times 1.15 ) + ( 5.75 \times 0.85 )}{2} ) = 6.267 … .$$

For the Individual User risk profile 516, risk scores for the individual users may be obtained from storage and used to generate a score for the team of users. The risk scores may be calculated using the same method as set out above, however, it will be appreciated that other methods may also be used. In this example, the risk properties for each of the users are:
Individual User 1=6.145 . . .
Individual User 2=3.194 . . .
Individual User 3=5.433 . . .

As there are three risk properties making up this risk profile, a score based on these may be calculated. As set out above, this may use the same method as for generating the overall risk score. A mean score is generated, and then used to determine weights for each risk property, the risk properties and weights are then used in the weighted average algorithm to produce a score for the Individual User risk profile 516. In this example, the Individual User Risk 516 Profile would be:

$$( \frac{\begin{matrix}( 6.1 45 … \times 1.541 … ) + \\ ( 3.194 … \times 0.232 … ) + ( 5.433 … \times 1.223 … )\end{matrix}}{3} ) = 5.608 … .$$

These risk profiles are obtained from the storage system 120 and used by the risk determinator 112 to generate a risk score. This risk score, as described above may be generated using a weighted average algorithm. The mean of the three risk profiles is obtained and equals 5.912 . . . . This mean is then used as an input into Equation 6 to determine the weights associated with each risk profile. In this example, where M is 3, the weights are:
Outbound risk profile 512 weight=0.898 . . .
OSINT risk profile 514 weight=1.118 . . .
Individual User risk profile 516 weight=0.983 . . .

These weights, along with the risk profiles can be input into the weighted average algorithm (Equation 7) to generate an overall risk score:

$$( \frac{\begin{matrix}( 5.608 … \times 0.898 … ) + \\ ( 6.267 … \times 1.118 … ) + ( 5.8 \; 62 … \times 0.983 … )\end{matrix}}{3} ) = 5.934 …$$

The risk score, as will be described below in relation to steps 230 and 240 of the method depicted in the flowchart 200 of FIG. 2, is then used by the server 110 to determine one or more adjustments 520 to make to a system. These adjustments 520 are determined with the aim of improving the risk mitigation/management and are then output to the system 140 via an API 130.

ii. Adjustment Determination

Returning the method 200 of FIG. 2, following the generation of the risk scores by the risk determinator 112, at step 230, the server 110 determines one or more adjustments to the properties of the system 140. The one or more adjustments are based on the risk score generated in step 220.

In some examples, the adjustments may be based on a predefined scale, for example the risk score may be used to categorize the entity, as follows:

TABLE 3

| Risk Score | Category |
|---|---|
| 1-2 | Absence of risk |
| 3-4 | Base line |
| 5-6 | Medium Risk |
| 7-8 | High Risk |
| 9-10 | Very High Risk |

Each of the categories may have predetermined settings for particular properties within the different systems capable of analysing the risk for the given entity. As such, the determined adjustments may be based on the changes needing to be made to those systems so that if an entity is currently in the base line risk category, but their generated risk score indicates they have moved to the high risk category, then the adjustments may be determined such that the properties of the system can be adjusted to match those required by the high risk category.

In other examples, the adjustments determined may be based on the generated risk score, in combination with the risk properties which made up that risk score. For example, if the risk score indicated that the entity should be in the medium risk category, but their Inbound risk property indicated they were at a very high risk of phishing attacks, whilst no overall adjustments to the system may be required (if the risk category hasn't changed), then other adjustments may be enacted to address their very high risk of phishing attacks.

These adjustments may be made to both internal and external systems, for example Egress Defend®, Egress Protect®, and other third-party systems such as the KnowBe4® training platform.

There are a number of different adjustments which may be enacted as will be described below. It will be appreciated that the adjustments described are not limiting and the skilled person will understand that other adjustments may be made.

One adjustment is the threshold for determining whether a communication is deemed suspicious and/or dangerous (e.g., in relation to the Inbound risk profile). That is, an entity with higher overall risk scores may have more communications deemed to be suspicious and/or dangerous by adjusting the threshold down. The amount the threshold may be adjusted may be proportional to the score for that risk property.

Another adjustment include adjustments to a quarantine for a received communication. Where an entity is deemed to be of higher risk, the adjustment determined may comprise lowering threshold for determining whether a communication should be quarantined, automatically quarantining all communications, and/or increasing/decreasing the period of time communications are quarantined for.

Data may also be stripped from incoming communications at differing levels based on the entity's risk score. For example, attachments may be removed from the communications. The determined adjustment may comprise lowering the threshold for stripping data when the risk score/category is high or increasing the threshold when the risk score/category is lower.

The frequency that links are rewritten in incoming communications may also be adjusted. This prevents entities from interacting with content of the communication without proper scrutiny. In particular, the frequency may be adjusted such that the higher the risk score/category, the more likely links are to be rewritten.

A trust level associated with the entity may also be adjusted, such that the higher the risk score/category, the lower the entity's trust level, and/or the easier it is for the entity's trust level to fall and the harder it is for the entity's trust level to rise.

A training profile associated with the entity may also be adjusted based on the risk score/category. For example, the higher the risk score/category, the increased amount of training for security-based (or other topics) may be suggested by the training provider. In some examples, the individual risk properties or risk profiles may be used to inform the topics the entity is suggested. For example, if their Inbound risk profile is high, then they are more likely to be a target of phishing attached, therefore increased training on phishing may be required to be undertaken by the entity using the training programme.

Entities having higher risk scores may also require additional scrutiny when sending communications, therefore, if an entity has a high risk score/category, any outgoing messages may be approved before sending.

Once it has been determined what adjustments are to be made, at step 240 of the method shown in the flowchart 200 of FIG. 2, the adjustments may be output to the system 140. The outputting of the adjustments to the system 140 may be through an API 130 configured to facilitate communication between the framework 100 and the system 140, such that data can be sent and received between them. The adjustments may then be implemented by the system 140, such that the risk management/mitigation associated with the entity accurately reflects the risk of the entity.

### 3. SYSTEM FOR DETERMINING ADJUSTMENTS AND GENERATING RISK SCORES

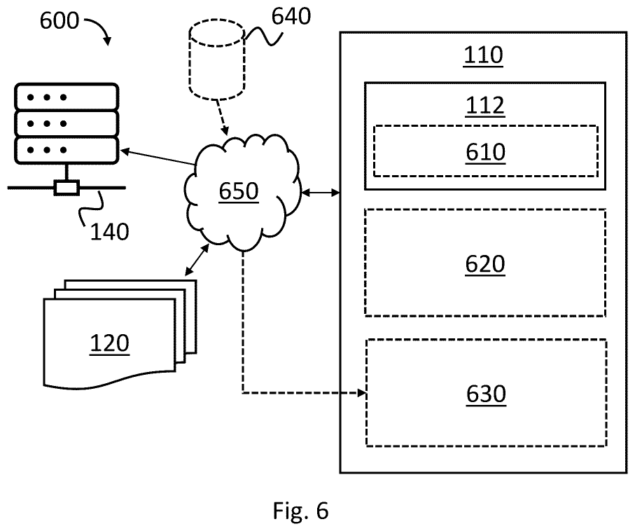

FIG. 6 shows a system 600 comprising hardware components configured for determining adjustments to make to another system 140 based on a risk score associated with an entity in accordance with method 200 described above in relation to FIG. 2. The system 600 comprises at least one server 110, storage system 120 and at least one other system 140. Each component may comprise a network adapter that is arranged to facilitate communication with any number of components via a network 650 such as a local area network (LAN), a general wide area network (WAN), and/or a public network (e.g., the Internet). The network adapter may be configured to communicate using either a wired or wireless communication method, such as cellular connectivity (LTE, 3G, 4G, or 5G), ethernet, or over a Wi-Fi network.

The system 600 comprises a storage system 120 having storage for storing risk profiles and risk properties associated with a number of entities, as described above in relation to method 200. The storage of the storage system 120 may be a solid-state drive (SSD) or other semiconductor-based RAM; a ROM, for example, a CD ROM or a semiconductor ROM; a magnetic recording medium, for example, a floppy disk or hard disk; optical memory devices in general, although it will be appreciated that other storage mediums may be used. The storage system 120 may be accessed via a local area LAN, a WAN, and/or a public network (e.g., the Internet) via the network adaptor. Whilst the storage system 120 is shown as separate from the other resources of the system 600, it will be appreciated that the storage system 120 may form part of the server 110, or another server such as an email server, or maybe a virtual component associated with a cloud computing implementation of the system 600. In yet further examples, the storage system 120 may be located on another server in a different location than the server 110.

The system 600 comprises a server 110 which may be implemented in hardware, or maybe an AWS server or other server provided by a cloud services provider; furthermore, multiple remote servers may be used, each being provided by separate cloud computing service providers to provide the services required to implement the method 200 described above. The server 110 may be configured on the same network as the other system 140 or storage system 120, or alternatively may be accessed via an external network such as the Internet.

The server 110 comprises at least some of the components for implementing method 200 described above in relation to FIG. 2. In particular, the remote server 110 may comprise a processor (not shown) configured to undertake processing to generate the risk score using the risk determinator 112. The risk determinator 112 as described above is configured to determine risk scores associated with different entities and also determine scores for risk profiles based on their associated risk properties.

The risk determinator 112 may comprise a weighted average module 610 configured to implement the weighted average method described above. The weighted average module 610 may be hardware implemented so as to provide the efficient calculation of the weighted averages. It will be appreciated that where other methodologies are used to generate the risk scores similar hardware modules may be implemented in the risk determinator 112.

The server 110 may also comprise a risk property analysis module 620. The risk property analysis module 620 may analyse the risk properties retrieved from the storage system 120 and where appropriate calculate the risk property score based on a predetermined decay variable. The risk property analysis module 620 may implement the methodology described above in relation to generation adjustments and the relative weighting of data based on how recent the data is. It will be appreciated that where other methodologies are used to generate the risk properties similar hardware modules may be implemented in the risk determinator 112.

The server 110 may comprise a network connection module 630 configured to obtain data from at least one third-party source 640 via the network 650. The network connection module 630 may form part of the network adaptor described above and be configured to obtain data such as OSINT data or training profile data held by a third party training organisation. This data may be used by the risk determinator 112 to generate the risk scores.

The server 110, is configured to determine one or more adjustments to the other system 140 based on the risk score generated by the risk determinator 112. These adjustments may be output, through an API, to the other system 140 over the network 650.

### 4. CONCLUSION

At least some aspects of the embodiments described herein with reference to FIGS. 1-6 comprise computer processes performed in processing systems or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

It is to be understood that although some of the disclosure above relates to the use of cloud computing, the implementation described is not limited to a cloud computing environment. Rather, embodiments of the present disclosure are capable of being implemented in conjunction with any other type of computing environment.

In the preceding description, for purposes of explanation, numerous specific details of certain examples are set forth. Reference in the specification to “an example” or similar language means that a particular feature, structure, or characteristic described in connection with the example is included in at least that one example, but not necessarily in other examples.

The above embodiments are to be understood as illustrative examples of the disclosure. Further embodiments of the disclosure are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the disclosure, which is defined in the accompanying claims.

What is claimed is:

1. A method of adjusting properties of at least one system based on a risk score associated with an entity, using a framework, the framework comprising:
a server comprising a risk determinator;
at least one application programming interface, API, facilitating communication between the server and the at least one system; and
storage for storing at least one risk profile associated with the entity and at least one risk property associated with each of the at least one risk profile, wherein the method comprises configuring the server to perform the steps of:
obtaining, from the storage, the at least one risk profile associated with the entity, wherein each risk profile is generated by the risk determinator, and based on at least one risk property associated with the at least one risk profile;
generating, by the risk determinator, the risk score associated with the entity based on the at least one risk profile;
determining, by the server, at least one adjustment to the properties of the system based on at least the risk score; and
outputting, through the API, the one or more adjustments to the at least one system.

2. The method according to claim 1, wherein the entity is an individual user, a group of associated users within an organisation, or all users associated with the organisation.

3. The method according to claim 2, wherein when the entity is all users associated with the organisation, at least one of the risk profiles is the risk score generated by the risk determinator based on the group of users within the organisation, and/or one or more individual users.

4. The method according to claim 2, wherein when the entity is the group of associated users within the organisation, at least one of the risk profiles is the risk score generated by the risk determinator based on one or more of the individual users in the group of associated users within the organisation.

5. The method according to claim 1, wherein generating the risk score comprises applying a weighted average algorithm.

6. The method according to claim 5, wherein the weighted average algorithm comprises:
calculating a mean for a plurality of risk profiles;
for each risk profile, calculating a weight based on the distance from the mean;
multiplying each of the plurality of risk profiles by the calculated weight to determine a plurality of weighted risk profiles; and
calculating a mean of the plurality of weighted risk profiles.

7. The method according to claim 1, wherein the one or more adjustments to the at least one system comprises at least one of:
lowering the risk score threshold required for a communication to be deemed suspicious or dangerous;
automatically quarantining incoming messages for a period of time;
requiring outgoing messages to be approved;
reducing the rate at which an entity's trust level increases;
increasing data analysis by machine learning models for a higher-risk entity;
blocking an entity from interacting with content in; and
amending an entity's training profile in a training system.

8. The method according to claim 1, wherein the at least one of the risk profile and the at least one risk property are based on an entity profile associated with the entity, and obtained from at least one of:
a third-party source; and
data stored on the internet.

9. The method according to claim 1, wherein the at least one risk profile comprises at least one of:
inbound communication data;
outbound communication data;
open-source intelligence, OSINT, data;
data associated with the system;
data associated with the entity; and
the entity's training profile held by a third-party training organisation.

10. The method according to claim 1, wherein the at least one risk property is based on an analysis of one or more properties associated with the at least one risk profile at a given point in time or based on a predetermined decay variable.

11. A system for adjusting the properties of at least one other system based on a risk score associated with an entity, the system comprising:
a server comprising a risk determinator and an application programming interface, API, for facilitating communication between the server and the at least one other system; and
storage for storing at least one risk profile associated with the entity and at least one risk property associated with each of the at least one risk profile;
wherein the server is configured to:
obtain, from the storage, the at least one risk profile associated with the entity, wherein each risk profile is generated by the risk determinator, and based on at least one risk property associated with the at least one risk profile;
generate, by the risk determinator, the risk score associated with the entity based on the at least one risk profile;
determine at least one adjustment to the properties of the system based on at least the risk score; and
output, through the API, the one or more adjustments to the at least one other system.

12. The system according to claim 11, wherein the risk determinator comprises a weighted average module for applying a weighted average algorithm for generating the risk score.

13. The system according to claim 11, wherein the server comprises a risk property analysis module for generating the at least one risk property based on an analysis of one or more properties associated with the at least one risk profile at a given point in time or based on a predetermined decay variable.

14. The system according to claim 11, wherein the server comprises a network connection module for obtaining data from at least one third-party source, the data from the at least one third-party source comprising:
open-source intelligence, OSINT, data; and
the entity's training profile held by a third-party training organisation.

15. A non-transitory computer-readable storage medium comprising a set of computer-readable instructions stored thereon, which when executed by at least one processor are arranged to adjust properties of at least one system based on a risk score associated with an entity, using a framework, the framework comprising:
a server comprising a risk determinator;
at least one application programming interface, API, facilitating communication between the server and the at least one system; and
storage for storing at least one risk profile associated with the entity and risk property associated with each of the at least one risk profile;
wherein the server is configured to perform the steps of:
obtaining, from the storage, the at least one risk profile associated with the entity, wherein each risk profile is generated by the risk determinator, and based on at least one risk property associated with the at least one risk profile;
generating, by the risk determinator, the risk score associated with the entity based on the at least one risk profile;
determining at least one adjustment to the properties of the system based on at least the risk score; and
outputting, through the API, the one or more adjustments to the at least one system.
